(19) United States
(12) Patent Application Publication
(10) Pub. No.: US 2018/0360070 A1
(43) Pub. Date: Dec. 20, 2018

(54) FROZEN DESSERT BASED ON WHEY PROTEINS

(71) Applicant: Karen MCINTOSH, Umhlanga (ZA)

(72) Inventor: Karen MCINTOSH, Umhlanga (ZA)

(21) Appl. No.: 16/060,941

(22) PCT Filed: Jan. 27, 2016
(86) PCT No.: PCT/ZA2016/050004

§ 371 Date: Jun. 9, 2018

(51) Int. Cl. A23G 9/36; A23G 9/40; A23G 9/42

(52) U.S. Cl. CPC A23G 9/363; A23G 9/366; A23V 2250/54252; A23G 9/42; A23V 2002/00; A23G 9/40

(57) ABSTRACT

The present invention relates to a frozen dessert, in particular an ice cream which is based on a whey protein isolate resp. a whey protein concentrate. Additionally, the composition contains probiotics, low glycemic index sweeteners as well as microencapsulated vitamins and minerals.

### FIELD OF THE INVENTION

In this document “Recipe methods of preparing whey protein with fortified frozen dessert” can be known and resembled as “the invention” and/or “the recipe”. “The invention” and/or “the recipe can be resembled as “Recipe methods of preparing whey protein with fortified frozen dessert”

In this invention the nutritional properties of frozen dairy-based desserts fortified by the addition of vitamin, minerals and probiotics are further enhanced by the addition of whey protein in the form of whey protein isolate or whey protein concentrate. The inventors thus aim to market their frozen desserts as nutritionally more beneficial to people of all ages than the standard frozen diary-based desserts.

### BACKGROUND OF THE INVENTION

In this modern age, food technology is developing and innovating like all other industries; and food innovation is not standing back for anything. New food products are innovated daily and many recipes are created out of nutritional need; a good NRV balance or NRV benefit; and out of reasons to create new products and markets; to be product competitive; to stand out or be exempted above certain products for market share and company revenue need.

In any company a decent sales profit is an imperative. Innovative products are a way ahead.

Newly innovated cutting edge food products that come to mind in the last two decades are for example: energy drinks, energy sachets and various uniquely supplemented chocolate, muesli and energy bars; protein shakes enhanced with creatine; smoothies and milkshakes; flavoured milk and vitamin enriched sweets and gums. The list is endless.

Many of these products are formulated to give the consumer a quick energy spike, to enhance athletes' levels of stamina, to counter nutritional depletion or to boost concentration.

Understanding trends is vital to identifying future growth opportunities. Health and wellness has been at the forefront of consumers' minds for quite some time now. It is a mega trend that continues to mature in the market place and as a result, growth opportunities are ripe for brands to harvest. Consumers are shifting to the position, whether it is true not, that natural is good and processed is bad.

To quote Sarah Medina in Nov. 8, 2010 edition of Key Trends in Functional Food Products:

“Imagine taste, function and nutrition all rolled up into one product—that is exactly what consumers are demanding nowadays. Consumers don't just want juice; they want natural juice that contains added vitamins and minerals. They have come to realize the effects of diet on health, and are actively seeking functional food products that enhance health beyond basic nutritional needs”.

We have responded by developing an innovative wellness product that addresses the concern for adequate nutrition by initially bringing to market a nutrient dense Ice Cream Food named Miss K Ice Cream Food (trademarked).

Ice cream needs no introduction. Young and old alike are lured by the combination of creamy mouth feel, sweet taste and easy eating. In 2013, the global ice cream market is forecast to have a value of R540 billion, an increase of 20.3% since 2008. However, traditional ice cream and other frozen dairy desserts are too high in fat content and are furthermore sweetened with high GI sweeteners leading health conscious consumers to be wary of indulging.

That's where “Recipe methods of preparing whey protein with fortified frozen dessert” comes in. “The invention” relates to fortified frozen dessert the ingredients of which include whey protein and the process of delivering it to the recipe's mix.

It is the manufacturers of the products direct intention to initially produce a fortified ice cream employing the additional processes of cooking and formulating whey protein to produce a health style and healthy product that brings a new approach to traditional delivery of frozen desserts, in particular ice cream.

In addition, vitamins and minerals are introduced to the mix in a microencapsulated form, protecting them against degradation during processing as well as limiting the introduction of the off flavours which they can impart to a product.

Ice cream has hardly ever been seen as food. “The recipe” changes that in the fact that it is not just a great tasting treat, dessert or pudding but also a food product. This is what novel food invention requires. An ice cream that is a double edge sword is invented.

A person can now choose to purchase a fortified ice cream for example instead of the usual energy bar or other edible supplements. Children who are fussy eaters or are unwell can be given this product with parents being assured that they are still receiving adequate nutrition. Convalescents or elderly people with little appetite can similarly be given an appealing and easily digested meal replacement. This fortified ice cream opens up a new revenue model for “the invention” and this is then a primary purpose of “the invention”.

The methods of “the invention” allow for the inclusion of solids not traditionally found in frozen desserts and/or ice cream, while retaining standard operating procedures and manufacturing equipment established for commercial manufacturing.

### OBJECT OF THE INVENTION

“The invention” prepares an “ice cream food”.

The object of “the invention” is to prepare a recipe for a fortified ice cream that is not only a dessert or pudding but a healthy food alternative; so healthy it can be eaten for breakfast, lunch or dinner due to the improved nutritional profile in “the recipe”; compared to normal ice cream.

The recipe “objective” on the other hand is to increase the protein content of standard ice cream to act as reasonable food. The methods of the recipe have done this through the addition of the whey protein isolate or concentrate in addition to the other nutritious ingredients.

### SUMMARY OF THE INVENTION

In summary, what is unique in our product is the alteration of standard ice cream with the objective of offering a more complete food—hence our use of the term “ice cream food”.

Our vitamins and minerals are delivered in the form of encapsulated vitamins and minerals. This new technology helps to remove the flat or stale taste vitamins and minerals can give thereby protecting the flavour of the combined recipe.

In cheese production whey is made as a by-product being one of the components that separate from milk during cheese production. Whey is scientifically proven to be the highest BV (Biological Value) protein available in nature. “The recipe” takes advantage of this whey protein to give the consumer around 20% of his or her daily requirement of protein per reasonable portion. Furthermore “the recipe” may contain fortified elements including probiotics, vitamins and minerals as the frozen dessert or ice cream is fortified. The protein in whey protein combines with these nutrients, to give a better nutritionally balanced frozen dessert option.

“The recipe” has allowed an increase in protein level to 10% of the Recommended Daily Allowance per 125m1 portion or 20% per 250m1 portion through the use of the whey protein isolate. It would be virtually or near impossible to do this while retaining the integrity of the product—mouth feel, taste, digestion, shelve life etc. without using an isolated or concentrated milk protein. Therefore an ISOLATED or CONCENTRATED milk protein is used; specifically an ISOLATED or CONCENTRATED whey protein, as it is known in the description of “the recipe”.

The cost of these forms of whey is significantly higher than the whey routinely used by ice cream manufacturers. As the aim of whey addition to ice cream is generally to lower cost, the expensive concentrate and isolate are avoided.

Whey protein is commonly marketed and ingested as a dietary supplement, muscle builder, etc. in many sports nutrition and energy products.

### Ingredients Tables

| ITEM | NAME | DESCRIPTION | COMPOSITION |
|---|---|---|---|
| Polydextrose | | Synthetic polymer | |
| | | of glucose | |
| A commercially | — | Fully integrated | — |
| available | | blend of food-grade | |
| blend of: | | emulsifier and | |
| Stabilisers and | | stabilisers | |
| emulsifiers | | Consist of uniform | |
| | | yellowish beads | |
| Whole milk | | Powder | Milk in |
| powder | | | powder |
| | | | form |
| Whey protein isolate | | Isolated whey | Whey protein |
| | | protein (higher | isolated at |
| | | concentrate than | 93% |
| | | normal whey | density |
| | | powder) | |
| Eggs | | Chicken eggs | Egg yolk etc. |
| Cream | | Normal cream | Normal cow |
| | | | cream dairy |
| Agave powder | | Diabetic used “type | Oligofructose |
| | | fructose/sugar” | |
| | | from the Agave | |
| | | (Tequila) plant | |
| Probiotic | | Proprietary strains | Bacillus |
| | | of Bacillus | coagulans |
| | | coagulans | |

| | |
|---|---|
| Mixture of Vitamins | VITAMINS: |
| and Minerals that | Vitamin A (Retinol) |
| can include/exclude | Vitamin B1 (Thiamine) |
| but not limited | Vitamin B2 (Riboflavin) |
| for example: | Vitamin B3 (Niacin/nicotinic acid) |
| | Vitamin B5 (Panthothenic acid) |
| | Vitamin B6 (Pyridoxine) |
| | Vitamin B9 (Folate) |
| | Vitamin B12 (Cobalamin) |
| | Vitamin C (Ascorbic acid) |
| | Vitamin D (Cholecalciferal) |
| | Vitamin E (Tocopheral) |
| | Vitamin H (Biotin) |
| | SALTS OF: |
| | Calcium |
| | Sodium |
| | Copper |
| | Iodine |
| | Iron |
| | Magnesium |
| | Manganese |
| | Molybdenum |
| | Phosphorus |
| | Potassium |
| | Selenium |
| | Zinc |

TABLE 2
Example of a typical nutrient profile of
“Recipe methods of preparing whey protein
with fortified dessert” described in this document

| | | | | % SOUTH |
|---|---|---|---|---|
| | | | PER | AFRICAN |
| | | PER | SERVING | NRV* PER |
| NUTRIENT | UNIT | 100 G | (125 ML) | SERVING |
| Energy | kJ | 741 | 661 | |
| Protein | g | 6.7 | 6.0 | 11 |
| Total carbohydrate | g | 23.0 | 20.5 | |
| Glycaemic | G | 5.3 | 4.8 | |
| carbohydrate | | | | |
| Total Fat | g | 5.4 | 5.7 | |
| Monounsaturates | g | 1.7 | 1.5 | |
| Polyunsaturates | g | 0.3 | 0.2 | |
| Saturates | g | 4.2 | 3.8 | |
| Trans fatty acids | G | 0.3 | 0.2 | |
| Omega 6 Fatty acid | mg | 210 | 188 | |
| VITAMINS | | | | |
| Vitamin A | μg | 144.4 | 129.0 | 14 |
| Vitamin B1 | mg | 0.2 | 0.2 | 15 |
| (Thiamine) | | | | |
| Vitamin B2 | mg | 2.7 | 0.2 | 15 |
| (Riboflavin) | | | | |
| Vitamin B3 | mg | 2.7 | 2.4 | 15 |
| (Niacin/nicotinic acid) | | | | |
| Vitamin B5 | mg | 0.8 | 0.8 | 15 |
| (Panthothenic acid) | | | | |
| Vitamin B6 | mg | 0.3 | 0.3 | 15 |
| (Pyridoxine) | | | | |
| Vitamin B9 (Folate) | μg | 67 | 59.8 | 15 |
| Vitamin B12 | μg | 0.7 | 0.7 | 28 |
| (Cobalamin) | | | | |
| Vitamin C | mg | 12.3 | 11.0 | 11 |
| (Ascorbic acid) | | | | |
| Vitamin D | μg | 2.3 | 9.1 | 14 |
| (Cholecalciferal) | | | | |
| Vitamin E | mg | 2.5 | 2.1 | 15 |
| (Tocopheral) | | | | |
| Vitamin H (Biotin) | μg | 3.2 | 2.8 | 9 |
| MINERALS | | | | |
| Calcium | mg | 95.7 | 85.4 | 7 |
| Sodium | mg | 72.7 | 64.9 | NA |
| Copper | mg | 0.2 | 0.1 | 15 |
| Iodine | μg | 24.0 | 21.4 | 14 |
| Iron | mg | 1.9 | 1.7 | 9 |
| Magnesium | Mg | 47.1 | 42.0 | 10 |
| Manganese | mg | 47.1 | 0.4 | 15 |
| Molybdenum | μg | 7.7 | 6.9 | 15 |
| Phosphorus | mg | 160.4 | 143.2 | 11 |
| Potassium | mg | 129.9 | 116.0 | NA |
| Selenium | μg | 8.5 | 7.6 | 14 |
| Zinc | mg | 1.8 | 1.6 | 15 |

Table 3: Below gives a typical amino acid profile for “Recipe methods of preparing whey protein with fortified dessert” described in this document. The percentage of reference amino acids is well above those recommended by the FAO/WHO/UNU in 2007.

| Reference amino | Suggested | Example of amino | Amino acids |
|---|---|---|---|
| acid pattern | amino acids | acids in Miss K | expressed as |
| per 1 g | for children | Ice Cream Food | % of reference |
| protein | 1-10 years | per 1 g protein | amino acids |
| Histidine (g) | 0.0135 | 0.014 | 126.28 |
| Isoleucine (g) | 0.025 | 0.048 | 190.14 |
| Leucine (g) | 0.049 | 0.081 | 166.05 |
| Lysine (g) | 0.04 | 0.068 | 170.32 |
| Methionine plus | 0.02 | 0.041 | 203.52 |
| cysteine (g) | | | |
| Phenylalanine | 0.035 | 0.062 | 175.20 |
| plus | | | |
| tyrosine (g) | | | |
| Threonine (g) | 0.0205 | 0.045 | 220.37 |
| Tryptophan (g) | 0.0056 | 0.012 | 221.27 |
| Valine (g) | 0.0325 | 0.052 | 158.94 |

### Description of the Manufacturing Process Diagram

After the stabilizer/emulsifier and polydextrose mix are soaked overnight; the whole milk powder, whey protein isolate, agave powder and egg yolk are mixed with the stabilizer mixture. The protein level* of the whey isolate is 20% of the recommended daily allowance per 250 ml serving due to the high level grade of the whey isolate used. The process above preserves the nutrient ratios; and the combined product ingredients and processes using heat, water, air and cooling to certain estimated margins; constitutes and underline the novelty of the “the invention” or “Recipe methods of preparing whey protein with fortified dessert”

### Brief Description of the Components of Matter 1. Polydextrose:

It is an indigestible synthetic polymer of glucose. It is a food ingredient classified as soluble fibre.

2. A commercially available blend of stabilisers and emulsifiers:

These enhance the process robustness and product quality in terms of texture, appearance and shelf life, helping to reach the nutrition targets, like low fat, low sugar, with no compromise on stability and texture.

3. Whole milk powder:

Powdered milk or dried milk is a manufactured dairy product made by evaporating milk to dryness.

4. Whey protein isolate

Protein powder also comes in different grades: concentrates, isolates, and hydrolysates. Each of these protein types and grades has unique properties and tastes.

5. Eggs yolks and/or whole eggs

Ice cream contains egg yolks, which help make it soft, rich, smooth, creamy, custardy.

6. Cream

Cream gives great flavour for ice cream.

7. Agave powder

Agave powder is a nutritious sweetener with a neutral, clean, mildly sweet flavour that makes it a perfect substitute for sugar.

8. Probiotic

Probiotics are organisms such as bacteria or yeast that are believed to improve the immune system and promote a healthy digestive system. A spore-forming bacterium that survives freezing is uniquely used in this product.

9. Microencapsulated mixture of Vitamins and Minerals

The microencapsulated vitamin and mineral mix used is unique to our ice cream and has been specifically tailored to enhance the intrinsic nutritional value of the ice cream.

The use in this recipe of microencapsulated vitamins and minerals is a unique application of this technology and prevents the introduction of off tastes that certain vitamins and minerals would bring to the product.

10. Ice cream density

Ice cream density is not compromised in “the recipe” formula as a density of around 649 gram/litre is still achieved in “the recipe”. This matches the density anticipated by the general public for a milk and cream-based frozen dessert.

### Detailed Description of the Components of Matter 1. Polydextrose

Polydextrose is an indigestible synthetic polymer of glucose.[1] It is a food ingredient classified as soluble fiber. It is frequently used to increase the non-dietary fiber content of food, to replace sugar, and to reduce calories and fat content. It is a multi-purpose food ingredient synthesized from dextrose (glucose), plus about 10 percent sorbitol and 1 percent citric acid.

Polydextrose is commonly used as a replacement for sugar, starch, and fat in commercial beverages, cakes, candies, dessert mixes, breakfast cereals, gelatins, frozen desserts, puddings, and salad dressings. Polydextrose is frequently used as an ingredient in low-carb, sugar-free, and diabetic cooking recipes. It is also used as a humectant, stabiliser, and thickening agent.

Polydextrose is a form of soluble fiber and has shown healthful prebiotic benefits when tested in animals. It contains only 1 kcal per gram and, therefore, is able to help reduce calories.

Polydextrose is known in the US by the brand names Litesse, Sta-Lite, and Winway. 2. Cremodan

Half the world's ice cream products contain Cremodan ingredients to obtain desired sensory properties and stability through shelf-life.

For more than half a century, Cremodan have solved the challenges of the frozen desserts industry, including today's demands for low/no sugar and fat formulations.

Cremodan enable stable air incorporation and help you achieve the textures, melting properties and heat-shock tolerance you want for a product.

3. Whole milk powder

Powdered milk or dried milk is a manufactured dairy product made by evaporating milk to dryness. One purpose of drying milk is to preserve it; milk powder has a far longer shelf life than liquid milk and does not need to be refrigerated, due to its low moisture content. Another purpose is to reduce its bulk for economy of transportation. Powdered milk and dairy products include such items as dry whole milk, non-fat dry milk, dry buttermilk, dry whey products and dry dairy blends.

4. Whey protein isolate

Amino acids get shuttled to your “hungry” muscles faster with a protein shake than with whole food protein such as chicken, fish or lean red meats. The best type of protein powder for this situation is whey protein. Protein powder also comes in different grades: concentrates, isolates, and hydrolysates.* Each of these protein types and grades has unique properties and tastes.

Protein concentrates. Protein concentrates are created by pushing the protein source (milk, whey, etc.) through a very small filter that allows water, minerals, and other organic materials to pass though. The proteins, which are too big to pass through the filter, are collected, resulting in protein powder. When this process is used to make whey protein concentrate, it yields a protein powder that is 70-85% protein and up to 5% lactose. People with lactose intolerance will have trouble consuming large amounts of whey protein concentrate.

Protein isolates. This is the next step up in purification; the protein is purified again using more filtration or a technique called ion-exchange or cross-flow microfiltration. Protein isolates have very low levels of carbohydrates and fat and are almost exclusively pure protein. People with lactose intolerance usually don't have trouble with whey protein isolates. Many companies that make whey protein isolates certify that their product is lactose free or they will even add lactase which is an enzyme that breaks down lactose to the protein powder to help with digestion.

“The recipe” uses protein isolates but could in another embodiment of the invention use protein concentrates.

5. Eggs yolks and/or whole eggs

Two main base recipes for ice cream include:
French style ice cream contains egg yolks, which help make it soft, rich, smooth, creamy, custardy.
Philadelphia style ice cream (sometimes called American style) has no eggs, and relies on the fat in the cream to keep it soft, but will still never be as rich and smooth as French style, and will still tend to freeze harder.

In our recipe, eggs are also included as a healthy further source of protein.

6. Cream

Pure cream high in milk fat is considered best for ice cream.

Cream is a dairy product that is composed of the higher-butterfat layer skimmed from the top of milk before homogenization. In un-homogenized milk, the fat, which is less dense, will eventually rise to the top. In the industrial production of cream, this process is accelerated by using centrifuges called “separators”. In many countries, cream is sold in several grades depending on the total butterfat content. Cream can be dried to a powder for shipment to distant markets.

7. Agave powder

Agave powder is a nutritious sweetener with a neutral, clean, mildly sweet flavour that makes it a perfect substitute for sugar. Extracted from all natural organic blue agave, this powder is an excellent source of dietary fibre and acts as a prebiotic to support intestinal health.

As an inulin, it has a very low impact on blood sugar levels making it ideal for diabetics.

Organic agave inulin powder is a healthy and natural sweetener that can be substituted for sugar. It's highly soluble in cold water and has a neutral taste, which makes it a great option for sweetening beverages and just about any recipe. Agave inulin powder improves the texture and tenderness of low-fat desserts which are often lacking in these areas due to an absence of ingredients. It also helps baked goods stay moist and acts as a binder in many foods.

Inulins are a group of naturally occurring polysaccharides produced by many types of plants,[1] industrially most often extracted from chicory.[2] The inulins belong to a class of dietary fibre's known as fructans. Inulin is used by some plants as a means of storing energy and is typically found in roots or rhizomes. Most plants that synthesize and store inulin do not store other forms of carbohydrate such as starch.

8. Probiotic

Probiotics are organisms such as bacteria or yeast that are believed to improve health. They are available in supplements and foods. The idea of taking live bacteria or yeast may seem strange at first. After all, we take antibiotics to fight bacteria. But our bodies naturally teem with such organisms.

The digestive system is home to more than 500 different types of bacteria. They help keep the intestines healthy and assist in digesting food. They are also believed to help the immune system.

Researchers believe that some digestive disorders happen when the balance of friendly bacteria in the intestines becomes disturbed. This can happen after an infection or after taking antibiotics. Intestinal problems can also arise when the lining of the intestines is damaged. Taking probiotics may help.

Mixture of Vitamins and Minerals Vitamins and minerals are essential nutrients that our bodies require so as to function properly. Vitamins and minerals boost the human immune system and promote normal growth and development in the human body.

9. Microencapsulation:

The encapsulation removes the flavour impact on the ice cream of the two nutrient group's vitamins and minerals at the concentrations in which we use them. Vitamins and minerals have unfamiliar, stale and sometimes bitter or sour tastes and this wants to be avoided as much as possible.

Micro-encapsulation is a process in which tiny particles or droplets are surrounded by a coating to give small capsules of many useful properties. In a relatively simple form, a microcapsule is a small sphere with a uniform wall around it. The material inside the microcapsule is referred to as the core, internal phase, or fill, whereas the wall is sometimes called a shell, coating, or membrane. Most microcapsules have diameters between a few micrometers and a few millimetres.

10. Ice cream density

Ice cream density level is debateable to the amount of taste it produces in the mouth. Although expensive ice creams all tend to have higher density the rule doesn't apply for all or each and every ice cream product.

It really becomes a matter of preference in taste, lifestyle and health to what Ice cream is suitable for the individual's consumption.

More expensive ice creams have higher “richness creamy” qualities like full cream, full cream milk solids and very sweet high sugar levels. Which do make them favourite's as treats in expensive restaurants, fancy deli's and the likes.

—-These ice creams serve different purpose—

Highly rich creamy flavoured Ice creams don't address healthy consumption but rather traditional sweet, creamy satisfaction to the best of their recipes.

That's why our “recipe” or “invention” substitutes healthy alternatives to sugar, and “creamy” creams. “The Recipe” adds other elements like probiotics, vitamins, minerals and sugar substitutes like agave. These elements reduce the gram to litre weight/mass of the ice cream, compared to the use of more intensified cream and milk solids, sugar and many other flavourings that aren't necessarily suitable for a healthier product ice cream.

However “the recipe” density still comes in at around 649 gram/litre. This is a recipe engineering achievement considering all the substitute ingredients used to make this a “healthy” Ice cream food.

Further notes on the “Recipe”:

11. Nutrient Reference Value (NRV)

The Nutrient Reference Values outline the levels of intake of essential nutrients considered to be adequate to meet the known nutritional needs of practically all healthy people for prevention of deficiency states.

NRVs have become part of daily life information for health conscious people as a means of monitoring their intake—either as a warning or as a measurement tool for total nutritional intake for a person. NRV's include the minimum, prohibited and allowed amounts for people of all ages including children.

“The recipe” prides itself that the NRV levels of the ensuing product contribute to healthy living and inspire consumer, parents and the like to purchase the product for a healthy alternative to standard Ice cream.

1. A Frozen nutritional dessert comprising:
Whey protein isolates or concentrates
Dairy or non-dairy base component,
Probiotics
A low GI sweetener
Various Vitamins and minerals using microencapsulation.

2. A Frozen nutritional dessert as in claim 1 for whey protein isolate; comprising an increase in the protein level to 20% of the Recommended Daily Allowance per 500 ml serving, through the use of concentrated whey protein (isolate or concentrate).

3. A Frozen nutritional dessert but more so an ice cream invented to serve as food but not compromising its acceptability as a treat, dessert or pudding.
